(19) United States
(12) Patent Application Publication
(10) Pub. No.: US 2025/0189941 A1
(43) Pub. Date: Jun. 12, 2025

(54) METHOD AND DATA-BASED ASSISTANCE SYSTEM FOR OPTIMAL ADJUSTMENT OF A TEXTILE MACHINE

(71) Applicant: Rieter Automatic Winder GmbH, Heinsberg (DE)

(72) Inventors: Lars APPEL, Übach-Palenberg (DE); Marko WISCHNOWSKI, Übach-Palenberg (DE)

(21) Appl. No.: 18/842,464

(22) PCT Filed: Feb. 28, 2023
(86) PCT No.: PCT/EP2023/054984

§ 371 Date: Aug. 29, 2024

(30) Foreign Application Priority Data
Mar. 2, 2022 (DE) 10 2022 104 904.3

(51) Int. Cl. G05B 13/04; G05B 13/02

(52) U.S. Cl. CPC G05B 13/042; G05B 13/0265

(57) ABSTRACT

A control method obtains an adjustment recommendation for a textile machine by receiving input parameters and automatically determining an adjustment recommendation suitable for the manufacture of a textile product by the textile machine. The adjustment recommendation determined as a function of the input parameters and affects one or more production parameters of the textile machine. An output parameter that contains data information from the adjustment recommendation is generated and used to change operation of the textile machine.

### RELATED APPLICATIONS

The present application claims priority to PCT Application Number PCT/EP2023/054984, filed Feb. 28, 2023, which claims priority to German Application No. 10 2022 104 904.3, filed Mar. 2, 2022. Both applications are incorporated by reference herein in their entirety.

### FIELD OF THE INVENTION

The invention relates to a method and a data-based assistance system for optimum adjustment of a textile machine for manufacturing a textile product.

### BACKGROUND

The manufacture of a defined textile product is complex and involves a large number of adjustments on a textile machine. The starting materials used, such as fibers, slivers, yarns and textiles, can have a high degree of variation in their properties due to natural fluctuations and the use of multiple blends. Almost all steps in the textile process chain require a high level of process know-how and almost all textile machines offer the operator a wide variety of process parameters and machine components to cover the material requirements. In addition, the complexity of materials to be processed, for example in the form of dual and triple core yarns or recycled materials, is increasing from year to year, making adjustment of the textile machine even more difficult.

For optimum adjustment of a textile machine, the adjustments must be selected to suit the starting material and the production target, such as maximum productivity or the highest quality. This adjustment is usually carried out by process experts. The adjustments include a large number of individual parameters. These parameters influence the productivity of both the textile machine and the downstream textile machines in the process chain, as well as the quality of the textile product produced by the textile machine or the downstream textile machine. Furthermore, the individual parameters have interdependencies and interactions with one another that affect the result of the production process.

The adjustment of the textile machine typically includes a selection of the specific machine components of the textile machine for production, such as clothing, rotors, splicing agents, bobbin holders and other machine components. This selection depends, among other things, on the starting material and the type of further processing of the textile product. Following component selection, adjustments are usually made to the production parameters, such as production speed, air pressure, draft, tension and speeds.

However, the textile machine's service booklets usually only provide a machine operator with a general guide to machine adjustments.

The quality of the machine adjustment therefore depends to a large extent directly on the expertise of the machine operator. It is particularly difficult for inexperienced machine operators to make good machine adjustments. However, training machine operators is very costly and time-consuming. In addition, more and more experienced machine operators and service staff from machine manufacturers are retiring. As a result, more and more machine operators and service staff with little experience are operating the machines and finding it difficult to find good machine adjustments. As a result, the best possible quality of the manufactured textile product is often no longer achieved and maintenance and repair costs increase due to the operation of textile machines that are not optimally adjusted.

### DESCRIPTION

The invention is therefore based on an object of providing a means which allows a machine operator to optimally adjust a textile machine without extensive prior knowledge, which thus also enables an inexperienced machine operator to reliably manufacture a high-quality textile product and which also, in particular, reduces the maintenance and repair costs of the textile machine in the best possible manner. Additional objects and advantages of the invention will be set forth in the following description, or obvious from the description, or learned through practice of the invention.

According to the invention, the objects are achieved by a method and a data-based assistance system described and claimed herein.

The method according to the invention for obtaining a recommended adjustment for a textile machine for manufacturing a textile product firstly carries out the method steps of receiving input parameters by means of a receiving unit. The input parameter(s) is/are at least information about
(i) a starting material from which the textile product is manufactured,
(ii) a machine type of the textile machine,
(iii) a production target of the textile machine or of a further textile machine downstream of the textile machine in the processing chain of the textile product, in particular with regard to the textile product to be manufactured by the textile machine or the further textile machine,
(iv) a type of further processing for the manufactured textile product following the manufacture of the textile product,
(v) climatic data prevailing in the production hall housing the textile machine and/or the other textile machine, and/or
(vi) at least one machine component of the further textile machine upstream and/or downstream of the textile machine in the processing chain of the textile product.

All of this information corresponds to conditions which, on their own or in a combination of at least two of the conditions, can have an influence on the manufacture of the textile product by the textile machine.

Subsequently, at least one suitable adjustment recommendation for the manufacture of the textile product by the textile machine and/or by the further textile machine is automatically determined by means of a determination unit, in particular stored in a data storage unit in a readable manner or newly generated by the determination unit and further preferably to be stored in the data storage unit after generation, for at least one specific machine component and/or for production parameters of the textile machine as a function of the received input parameters, wherein the determination unit is coupled to the receiving unit and in particular to the data storage unit in a data-transmitting manner. For the purposes of the present invention, a data-transmitting coupling can preferably be realized in a conventional manner in a wireless and/or wired manner. At least the receiving unit, the determination unit and/or the data storage unit can also preferably be formed by a computing unit. For the purposes of the present invention, a unit in the usual sense is understood to be a unit that consumes electrical energy.

Subsequently, according to the invention, selectable output parameters are output by means of an output unit, which output parameters contain information about the at least one determined adjustment recommendation, wherein the output unit is coupled in a data-transmitting manner at least to the determination unit.

This allows a desired production target to be achieved or a desired textile product to be manufactured based on the determined adjustment recommendation for the textile machine to match the starting material used.

The inventors have recognized that an optimized adjustment of a textile machine is only possible with many years of experience and is becoming increasingly complex due to the increasing number of adjustments to be made and the available machine components as well as the process chains, i.e. the processing chain with regard to the textile product. In addition, the inventors have recognized that only an electronic system can determine the optimum adjustments among the large number of possible combinations of the individual components and parameters, in particular due to the diverse interactions and dependencies between the individual components and parameters, without extensive and time-consuming tests, and only in this way can a consistently high quality of the textile product or the process product, for example a sliver material, a thread or a textile fabric, such as a fabric, be achieved. The method according to the invention advantageously enables adjustment of the textile machine with little to no prior knowledge. The machine operator is provided with adjustment recommendations for the best possible production of the desired textile product.

According to a further aspect of the present invention, a data-based assistance system for carrying out the method according to the invention is provided, in particular according to any of the embodiments described. Corresponding components of the data-based assistance system can preferably have corresponding configurations on the device side in order to be able to carry out or execute the process steps described.

The data-based assistance system can be a data storage unit comprising application software for a computing unit for carrying out the method or process steps and/or a device, in particular with at least one computing unit and/or a data storage unit. The data-based assistance system basically has the function of providing an adjustment recommendation for a machine operator based on data input and/or stored data. For the purposes of the present invention, an adjustment recommendation is to be understood as any recommendation that provides a selection of at least one parameter, a process sequence and/or at least one machine component. Such choices can also be understood as recommendations for action. The data-based assistance system supports the machine operator, in particular preferably in the processing of any starting materials and in particular preferably also complex starting materials, such as, purely by way of example, dual or triple-core yarns and/or recycled materials, in order to be able to produce a desired textile product. Starting materials with a fluctuating material quality can also be easily taken into account in this manner.

The method and/or the assistance system can preferably be operated with the integration of at least one platform and preferably simultaneously on at least two, i.e. several different platforms. The possible platforms can preferably be machine controls, human-machine interfaces, smartphones, handhelds, computers, servers, data watches, data glasses, laptops and any other computer and data processing systems. A general provision as a website or by means of a web server is also preferred. By way of example, the data-based assistance system can preferably be designed separately from a textile machine and, in particular, separately from a machine control unit of a textile machine as an independent and/or autonomous unit.

Possible applications of the method and the data-based assistance system are, for example, use in splicing, winding, ring spinning, rotor spinning, air spinning, friction spinning and yarn further processing, such as weaving, knitting, dyeing or similar. Accordingly, the textile machine is preferably a machine for carrying out one or more of these processes. Particularly preferably, the textile machine is a spinning machine or a winding machine with numerous identical workstations, wherein the method or the data-based assistance system can particularly preferably recommend the adjustment recommendations for each, a certain number or for all of the workstations, for the machine components or for at least one service unit operating the textile machine.

The process or the data-based assistance system provides optimized adjustments for the textile machine in order to produce the textile product as required. The textile product can be an end product, such as an item of clothing or a fabric, or an intermediate product for further processing, in particular for industrial processing, such as a sliver, a thread or a flat textile such as a piece of fabric.

According to the invention, the input parameter or parameters are received, wherein receiving in this context is understood to mean any supply of corresponding data to the receiving unit. According to a preferred embodiment, at least one input parameter can be entered manually at an input unit by a user, and/or at least one input parameter can be sent automatically, in particular in conjunction with a further computer system, at least one control unit of the textile machine and/or by means of a higher-level control system, for receipt by the receiving unit. Preferably, the receipt of the at least one input parameter is followed by a diagnosis of the input parameter, wherein the at least one input parameter is particularly preferably checked for a possible inconsistency, for conflicting production targets, for incompleteness, for values outside a usual area and/or generally for possible errors.

The input parameter can be any data information relating to the starting material used to manufacture the textile product, in particular the material properties, and/or the type of textile machine to be used to manufacture the textile product. The input parameters of the starting material can be, for example, the size, dimension, material, mechanical and/or chemical properties of the starting material. Further input parameters can be, for example, a yarn type, a material composition, a twist direction, a fineness, strength properties, fiber length distribution or similar. In addition, input parameters, for example climate information such as temperature or humidity, can be at least one machine component used to manufacture the textile product, a type of further processing of the textile product downstream of the manufacture of the textile product or at least one further textile machine upstream and/or downstream of the textile machine in the processing chain of the textile product. In addition, a production target of the textile machine or a further textile machine downstream of the textile machine in the processing chain of the textile product can be taken into account as part of the input parameters. For example, the textile machine can be a flyer or a draw frame whose textile product is a defined fiber sliver. A further textile machine downstream of the flyer or draw frame in the processing chain can be a ring spinning machine for the flyer and a rotor spinning machine or air-jet spinning machine for the draw frame, each of which produces a yarn as a textile product. For example, a production target of the textile machine, i.e.

the flyer or the draw frame in relation to the sliver, can be used as an input parameter. Alternatively or additionally, a production target of the other textile machine, i.e. the ring spinning machine, the rotor spinning machine or the air-jet spinning machine, can be used as an input parameter with regard to the yarn to be produced.

For the purposes of the present invention, a production objective, in particular with regard to the textile product to be manufactured, is generally to be understood as an objective for production, a requirement of the textile machine and/or a desired property of the resulting textile product.

The automatic determination of at least one adjustment recommendation for the manufacture of the textile product by the textile machine and/or by the further textile machine, which is stored in a readable form in a data storage unit, for at least one specific machine component and/or for production parameters of the textile machine as a function of the input parameter or parameters received is carried out in accordance with the invention by a determination unit which is designed in particular to be able to carry out an independent calculation and selection of the adjustment recommendation. As part of the automatic determination, a calculation is preferably carried out on the basis of at least one received input parameter, which optimizes the available production parameters and in particular variable production parameters and then determines a recommendation for a preferred adjustment based on the at least one received input parameter. For example, previously recorded data and/or stored data can also be taken into account during automatic determination. In the course of the automatic determination, an adjustment recommendation stored in a data storage unit can be determined or a new adjustment recommendation can be generated or created, which is then further preferably stored in the data storage unit so that it can be read out.

A specific machine component is understood in particular to be an interchangeable, variable, adjustable and/or optionally usable component, part and/or structural unit of the textile machine or the further textile machine. Production parameters are understood to mean at least some of the adjustments of the textile machine and preferably all adjustments that must be made to produce the textile product and/or are variable, i.e. can be varied by a machine operator.

The adjustment recommendation can be assigned either directly to a determined production parameter or to values derived therefrom, wherein the adjustment recommendation is preferably adapted to the respective inputs and/or values required by the textile machine for operation, so that these can only be output to the textile machine by a machine operator or alternatively automatically for the selection of one or more output parameters corresponding to the adjustment recommendation. When outputting for selection by the machine operator, the operator only has to accept or confirm the output parameter(s) corresponding to the adjustment recommendation. The output parameter(s) can in principle refer to all parameters that can be set on the respective textile machine, for example air pressure adjustments, process sequence adjustments and/or mechanical adjustments.

The output parameter or parameters correspond in particular preferably to an adjustment recommendation and particularly preferably to several adjustment recommendations, in particular in the form of several possible sets of adjustments to be preferred for the production of the textile product, taking into account the input parameter or parameters. It is particularly preferable for the output parameter(s) to be output to the machine operator together with explanatory information so that the operator can make a decision and appropriate selection based on this. Overall, the output parameter(s) may in particular be preferred production or target parameters, adjustments, defined processes and/or the component recommendations for the manufacture of the textile product.

The output of the output parameter or parameters is a suggestion, in particular for the machine operator of the textile machine, in order to achieve optimum production of the textile product, taking into account the input parameter or parameters. It is also preferred that the output parameter or the underlying adjustment recommendation is checked before output, in particular for possible inconsistencies, for values that conflict with the production target, for incompleteness, for values outside a normal area and/or generally for possible errors. In addition, a notification to the machine operator or a control device is particularly preferred if values or recommended components do not correspond to a standard recommendation and/or deviate significantly from established standard values.

A preferred embodiment of the method provides for the automatic determination step to be carried out using a database-based approach. The at least one input parameter is assigned directly to at least one specific output parameter. The direct assignment can be determined or calculated completely automatically or, in particular, specified by a machine operator. It is also conceivable to have the assignment calculated automatically and then checked and, if necessary, corrected by a machine operator and only then recorded in a data storage unit with fixed assignments.

In addition, according to a preferred embodiment, it is also conceivable that in a case in which there is no assignment of an output parameter to an input parameter in the data storage unit, it is possible to search for data records with input parameters that are as similar as possible and to make one or more adjustment recommendations based on the similarity and output them accordingly. It is possible to weight the recommendation or store the suggestion accepted by the machine operator as a future direct assignment and/or for weighting this suggestion selected by the machine operator. In addition, the receptacle of feedback from the machine operator after the start of production of the textile product and/or as part of a quality control of the textile product is conceivable in order to improve the quality of future recommendations and/or to exclude unsuitable assignments in the future.

It is generally preferred that the output of the output parameter(s) be stored and, in particular, stored as recipes that can be called up again later. Furthermore, it is preferably possible to exchange the outputs and, in particular, stored recipes between machine operators and/or between different textile machines or devices on which the method according to the invention is carried out. Storage can take place in any manner and at any storage location, for example locally, at the backend, centrally or decentrally.

In a further preferred further development, the step of automatic determination is carried out in addition to or as an alternative to a database-based approach by means of a model-based approach, which further preferably takes into account a relationship between the at least one input parameter and the production targets of the at least one output parameter from optimized or preferred adjustments and/or which also preferably further optimizes or improves the output parameter(s) by means of machine learning. Various models and methods can be used in the model-based approach. For example, simple decision tree models can be applied directly on the basis of the input parameter(s) or on the basis of parameters derived from them in order to obtain at least one output parameter.

A particularly preferred embodiment of the data-based assistance system provides for the automatic determination step to be carried out on the basis of statistical models and/or machine learning models in addition to or as an alternative to a database-based approach. The statistical model(s) can be, for example, regressions, random forests or support vector machines. The machine learning models are preferably deep learning models and neural networks are particularly preferred.

In order to enable continuous improvement of the method, in a preferred embodiment, data sets from input parameters and output parameters, in particular of optimum production parameters, optimized adjustments and/or component recommendations, are stored automatically and/or by a user and subsequently used continuously or intermittently to improve the automatic determination and in particular to improve existing prediction models or to generate new prediction models. It is generally preferred that the automatic determination step is based on one or more prediction models. Furthermore, a learning capability and thus a continuous improvement based on the data received, feedback from a machine operator, input from the manufacturer and/or the operator of the textile machine and/or from any other sources is generally preferred. It is particularly preferable that continuous or periodic co-learning is ensured in this manner.

In principle, the textile machine can be any machine that produces and/or processes a textile product, wherein a design as a yarn-producing or bobbin-producing textile machine is preferred. Depending on the type of textile machine, the production targets can differ significantly. For example, the production target(s) for a yarn-producing textile machine can be maximum yarn evenness, maximum productivity, a defined fineness, a defined twist, piecers which are as similar as possible to the yarn and/or the highest possible yarn quality. For a bobbin-producing textile machine, the production target(s) can be a specifically defined or maximum bobbin density, maximum productivity, a splice that is as similar as possible to the yarn and/or the highest possible quality. With other types of textile machines, such as weaving machines, a production target can be, for example, the uniformity or the level of basis weights. In the case of flyers, cards and draw frames, one production goal can be the uniformity or fineness of the sliver.

Preferably, the recommended adjustments for textile machine components issued by means of output parameters are, for example, specific clothings, rotors, spinnerets, drafting system components, ring traveler system, tube formats, take-off units, splicing means, bobbin holders and/or weaving machine type, reed, knitting machine type, knitting needle type. Recommendations can also be issued for components of other textile machines, which can be taken into account during the further processing of the textile product. These recommendations can be taken into account manually or automatically, for example, the latter in particular by coupling the textile machine and the other textile machine with one another to transmit data.

Further preferred recommended production parameters may include, for example, the production speed, air pressure, draft, tension and/or rotational speeds of the textile machine and/or the further textile machine.

Finally, an embodiment is preferred in which the input parameter or parameters are entered manually by the user of the textile machine and/or can be read out directly from the textile machine. Alternatively or additionally, it is preferred that the adjustment recommendations are entered manually into the textile machine, in particular into a human-machine interface, and/or transmitted directly to the textile machine. According to a preferred embodiment, input parameters can be read out from the textile machine and/or from the receiver unit and/or adjustment recommendations can be transmitted in any manner, in particular wired or wireless, for example by means of NFC, WLAN, USB or CAN.

As part of an automatic and/or continuous improvement of the method, in particular the adjustment recommendation to be output and/or the underlying models, it is also conceivable to integrate a material analysis test machine into the method or at least to connect the receiver unit to such a machine for data exchange. This allows the component and adjustment to be assigned directly to a material measurement and the result of the material measurement to be returned directly to the receiving unit.

An embodiment example of a method and data-based assistance system according to the invention is described in more detail below.

In order to achieve an optimal selection of machine components as well as a selection of the best possible adjustments of a textile machine, in particular a winding machine, and thus to be able to produce an optimal textile product, the machine operator first logs on to a data-based assistance system, for example by means of a tablet computer. This identification of the user helps to access data from previous uses, retrieve user-dependent adjustments and/or adapt the function of the assistance system to the user or their level of competence. In addition, favorites previously saved by this user or for this user can be called up.

In the next step, the user is asked to enter the parameters of the starting material and the textile machine used. The textile machine is identified by its type designation or serial number. It is also conceivable that the data-based assistance system is only provided for a specific type of textile machine, meaning that the detailed parameters of the associated textile machine are already stored and do not need to be entered.

As parameters of the starting material, information is first provided on the yarn component used as the starting material and, in particular, the type and/or material of the yarn used and the respective quantity of the materials are entered. Subsequently, the yarn properties of the starting material are either retrieved from the storage or entered by the user, wherein, for example, the yarn type, the twist direction of the yarn and the fineness of the yarn can be specified.

The data-based assistance system then automatically determines the ideal machine components, wherein the program suggests an optimal combination of splice components. This concerns, among other things, the type of splicer, the design of the opening pipe, the prism to be used, the design of the distributor plate and the distance between the scissors. Alternatively, the data-based assistance system also offers manual selection of the machine components, wherein, however, only splice components that are compatible with the starting material according to the recorded input parameters of the starting material are suggested and/or selectable. Finally, the user confirms which machine components are to be used in the data-based assistance system.

The textile product is manufactured on the basis of the input parameters received and the machine components recommended and output by the assistance system and subsequently selected or confirmed by the user. In particular, a prediction of opening and splice adjustments is made for the winding machine using machine learning models. These optimal adjustments can then be entered manually by the user at the bobbin winding machine control or the winding station, or they can be transmitted wirelessly directly from the data-based assistance system to the bobbin winding machine and/or the winding station. With these optimized adjustments and the selected optimal machine components, the best possible textile product can then be produced.

A further embodiment of a data-based assistance system differs from the previous embodiment only in that a production target is also requested from the user as part of the receptacle of input parameters, wherein the user can select, for example, the best possible quality of the textile product or a particularly high efficiency and/or speed of production of the textile product. This selection is then taken into account when recommending the optimized adjustments and/or recommending optimal components.

In order to improve the result of the recommendation of optimized adjustments and/or optimal machine components over time, the result of the recommendation can also be entered into the data-based assistance system. This can be done on the basis of information provided by the user about the textile product received, wherein the data-based assistance system queries various quality characteristics, such as the uniformity of the yarn, the deviations in the thickness of the yarn, the surface quality of the yarn and the occurrence of defects in the yarn flow. In addition, the data-based assistance system can also be linked to a quality control device or exchange data on the quality of the textile product and/or any faults that have occurred. Based on such feedback, machine learning models can then be used to improve the quality and accuracy of the recommendations in order to achieve an even better textile product.

The present invention is not limited to the embodiments shown and described. Modifications within the scope of the claims are possible, as is a combination of the features, even if these are shown and described in different embodiments.

1-14: (canceled)

15. A method for obtaining an adjustment recommendation for a textile machine for manufacturing a textile product comprising the steps of:
receiving input parameters via a receiving unit, wherein each of the input parameters contains at least one piece of data information about one or more of:
(i) a starting material from which the textile product is manufactured;
(ii) a machine type or at least one machine component of the textile machine required to manufacture the textile product;
(iii) a production target of the textile machine or of a further textile machine downstream of the textile machine in a processing chain of the textile product;
(iv) a type of further processing for the textile product following the manufacture of the textile product;
(v) climatic data prevailing in a production hall housing the textile machine; or
(vi) at least one machine component of the further textile machine upstream or downstream of the textile machine in the processing chain of the textile product; and subsequently
via a determination unit coupled with the receiving unit, automatically determining an adjustment recommendation suitable for the manufacture of the textile product by one or more of: (i) the textile machine, (ii) the further textile machine, or (iii) at least one machine component of the textile machine or the further textile machine, the adjustment recommendation determined as a function of the input parameters and affecting one or more production parameters of the textile machine;
via an output unit coupled to the determination unit, outputting one or more output parameters that contain data information from the adjustment recommendation;
changing operation of the one or more of: (i) the textile machine, (ii) the further textile machine, or (iii) at least one machine component of the textile machine or the further textile machine in accordance with the one or more output parameters.

16. The method according to claim 15, wherein the adjustment recommendation is read from a data storage unit or newly generated by the determination unit.

17. The method according to claim 15, wherein the automatic determination of the adjustment recommendation is performed via a database-based approach wherein the input parameters are automatically assigned to at least one of the output parameters.

18. The method according claim 15, wherein the automatic determination of the adjustment recommendation is performed via a model-based approach wherein a concrete relationship between at least one of the input parameters and at least one output parameter is defined.

19. The method according to claim 15, wherein the automatic determination of the adjustment recommendation is performed via one of: (i) a database-based approach wherein the input parameters are automatically assigned to at least one of the output parameters or (ii) a model-based approach wherein a concrete relationship between at least one of the input parameters and at least one output parameter is defined, and wherein prior to the automatic determination of the adjustment recommendation, a selection step for selecting the database-based or model-based approach takes place, wherein the selection is made manually by an operator or automatically based on predeterminable decision processes.

20. The method according claim 15, wherein the automatic determination of the adjustment recommendation is performed on the basis of statistical models or on the basis of machine learning models.

21. The method according to claim 15, wherein that input parameters and the output parameters are stored in a data storage unit in a readable manner and are subsequently used continuously or intermittently to improve existing prediction models or to generate new prediction models for the automatic determination of the adjustment recommendation.

22. The method according to claim 15, wherein the production target of the textile machine or of a further textile machine relates to the textile product and is one or more of: a uniformity, a weight, a maximum productivity, a defined fineness, a defined twist, a piecing that is as similar as possible to a yarn, a defined quality target, or a splice having a defined or maximum density that is as similar as possible to the yarn.

23. The method according to claim 15, wherein at least one of the input parameters is manually entered via an input unit coupled to the receiving unit.

24. The method according claim 15, wherein the output parameters contain information about components of the textile machine or the further textile machine, including one or more of: specific clothings, rotors, spinnerets, drafting system components, ring traveler system, tube formats, take-off units, splicing devices, bobbin holders, weaving machine type, reed machine type, knitting machine type, or knitting needle type.

25. The method according to claim 15, wherein the output parameters contain information about one or more of: production speed, air pressure, draft, tension, or rotational speed of the textile machine, further textile machine, or machine component of the textile machine or the further textile machine.

26. The method according to claim 15, wherein the input parameters are read out from the textile machine by a read-out unit and are transmitted to the receiving unit coupled to the read-out unit.

27. The method according to claim 15, wherein the one or more output parameters are manually entered at an input unit of the textile machine, the further textile machine, or machine component of the textile machine or the further textile machine, and are subsequently transmitted to a control device of the textile machine, the further textile machine, or machine component of the textile machine.

28. A data-based assistance system configured for performing the method according to claim 15.
